(19) United States
(12) Patent Application Publication
(10) Pub. No.: US 2018/0198362 A1
(43) Pub. Date: Jul. 12, 2018

(54) SWITCHED MODE POWER SUPPLY COMPENSATION LOOP

(71) Applicant: TELEFONAKTIEBOLAGET L M ERICSSON (PUBL), Stockholm (SE)

(72) Inventors: Magnus KARLSSON, Oskarshamn (SE); Andreas LARSSON, Kalmar (SE); Oscar PERSSON, Kalmar (SE)

(21) Appl. No.: 15/032,379

(22) PCT Filed: Apr. 29, 2015
(86) PCT No.: PCT/EP2015/059328

§ 371 Date: Apr. 27, 2016

(51) Int. Cl. H02M 1/15; H02M 1/14

(52) U.S. Cl. CPC H02M 1/15; H02M 2001/123; H02M 1/143

(57) ABSTRACT

A controller for controlling an output voltage of a switched mode power supply (SMPS) comprising a sampling module arranged to sample a signal indicative of the output voltage of the SMPS at a frequency higher than a switching frequency of the SMPS, and a filter module arranged to filter out a ripple component of the sampled signal, comprising: a ripple component estimation module arranged to estimate the ripple component by calculating, for each sample of a plurality of the samples of the signal, an average sample value using the sample value and sample values obtained at corresponding points in preceding switching periods of the SMPS, the sample at each of said corresponding points being separated from said sample of the plurality of samples by a respective integer number of switching periods of the SMPS. The controller further comprises a subtraction module arranged to subtract the estimated ripple component from the sampled signal to generate a filtered signal, and a switching control module arranged to generate a control signal for controlling at least one of the switching frequency and a switching duty cycle of the SMPS based on the filtered signal.

### TECHNICAL FIELD

The present invention generally relates to the field of switched mode power supplies (sometimes referred to as switch mode power supplies or switching mode power supplies) and more specifically to the feedback control loop of a switched mode power supply that is used to regulate the power supply's output voltage.

### BACKGROUND

The switched mode power supply (SMPS) is a well-known type of power converter having a diverse range of applications by virtue of its small size and weight and high efficiency, for example in personal computers and portable electronic devices such as cell phones. A SMPS achieves these advantages by switching one or more switching elements such as power MOSFETs at a high frequency (usually tens to hundreds of kHz), with the frequency or duty cycle of the switching being adjusted by a feedback loop (also widely referred to as a “compensation loop” or “feedback circuit”) to convert an input voltage to a desired output voltage. A SMPS may take the form of a rectifier (AC/DC converter), a DC/DC converter, a frequency changer (AC/AC) or an inverter (DC/AC).

The feedback loop typically comprises a controller that regulates the switching frequency or the switching duty cycle of the switching element(s) of the SMPS based on the output voltage of the SMPS, in accordance with a control law defined by one or more control law parameters, to keep the output voltage of the SMPS in the vicinity of a predetermined value. For example, the SMPS may comprise a Proportional-Integral-Derivative (PID) controller that regulates the duty cycle (or the switching frequency, as the case may be) of the switching element(s) to keep the output voltage of the SMPS constant, in accordance with a PID control law that is characterised by the values of the P, I and D control parameters set in the PID controller.

To achieve a good feedback loop response and avoid oscillations, digital SMPS controllers typically employ a filtering process that attenuates the usual voltage ripple that propagates to the feedback loop from the output of the SMPS. This voltage ripple is a substantially periodic oscillation in the output voltage of the SMPS, which is typically small in relation to the output voltage of the SMPS, and which may occur as a result of an incomplete suppression of an output alternating waveform by the SMPS's output filter. Conventional digital SMPS controllers usually attenuate the ripple component by oversampling the output voltage of the SMPS (or an error signal indicative of a difference between the output voltage and a reference voltage) and manipulating the oversampled signal using an appropriately configured Finite Impulse Response (FIR) or Infinite Impulse Response (IIR) filter, e.g. a moving average filter or a decimation filter. Such filtering processes cause the voltage ripple component of the oversampled signal to be suppressed, thus allowing the low-bandwidth signal (i.e. voltage deviations due to transients) to be obtained for use in output voltage regulation.

### SUMMARY

The present inventors have recognised that the conventional filter designs outlined above have the disadvantage of introducing a delay in the signal, which degrades the performance of the feedback loop. More particularly, these filter designs introduce a phase lag and distort the shape of the signal in the time domain, making real-time control of the SMPS's output voltage difficult or impossible.

As an example, FIG. 1 shows the output of a conventional moving average filter (dashed line) that is arranged to filter the error signal (solid line) in the SMPS's feedback loop. In this example, the moving average filter operates over 16 samples, which is the same as the number of samples in the switching period (an oversampling ratio of 16 is used). As can be appreciated from FIG. 1, although the moving average filter is effective in suppressing the ripple component, it causes the signal to be delayed and distorted during a transient event (beginning at time t=0.005 ms).

Having recognised these drawbacks, the present inventors have devised a scheme for controlling the output voltage of an SMPS which exploits the reproducibility (or near-reproducibility) of the ripple component over a number of switching periods during stable operation of the SMPS to obtain a good estimate of the prevailing ripple component. This estimate of the ripple component is subtracted from the feedback signal (e.g. the output voltage of the SMPS or the aforementioned error signal) to yield the remaining signal, which exhibits little or no delay or distortion. The ability of an embodiment of the present invention to effectively suppress the ripple component whilst leaving the remainder of the feedback signal substantially unchanged is illustrated by the dotted line in FIG. 1. The delay/distortion is considerably smaller than in the case of the conventional controller that employs a moving average filter.

More specifically, the inventors have devised a controller for controlling an output voltage of an SMPS, the controller comprising a sampling module arranged to sample a signal indicative of the output voltage of the SMPS at a frequency higher than a switching frequency of the SMPS, and a filter module arranged to filter out a ripple component of the sampled signal, comprising: a ripple component estimation module arranged to estimate the ripple component by calculating, for each sample of a plurality of the samples of the signal, an average sample value using the sample value and sample values obtained at corresponding points in preceding switching periods of the SMPS, the sample at each of said corresponding points being separated from said sample of the plurality of samples by a respective integer number of switching periods of the SMPS. The controller further comprises a subtraction module arranged to subtract the estimated ripple component from the sampled signal to generate a filtered signal, and a switching control module arranged to generate a control signal for controlling at least one of the switching frequency and a switching duty cycle of the SMPS based on the filtered signal.

The inventors have further devised a switched mode power supply comprising a controller as set out above.

The inventors have further devised a method of controlling an output voltage of an SMPS, the method comprising: sampling a signal indicative of the output voltage of the SMPS at a frequency higher than a switching frequency of the SMPS; estimating the ripple component by calculating, for each sample of a plurality of the samples of the signal, an average sample value using the sample value and sample values obtained at corresponding points in preceding switching periods of the SMPS, the sample at each of said corresponding points being separated from said sample of the plurality of samples by a respective integer number of switching periods of the SMPS; subtracting the estimated ripple component from the sampled signal to generate a filtered signal; and generating a control signal for controlling at least one of the switching frequency and a switching duty cycle of the SMPS based on the filtered signal.

The inventors have further devised a computer program product, comprising a signal or a non-transitory computer-readable storage medium carrying computer program instructions which, when executed by a processor, cause the processor to perform a method as set out above.

### BRIEF DESCRIPTION OF THE DRAWINGS

Embodiments of the invention will now be explained in detail, by way of example only, with reference to the accompanying figures, in which:

FIG. 1 shows measurements of a feedback error signal (solid line) during a period of time in which a voltage transient is observed, together with measurements of the output of a conventional moving average filter (dashed line), and of the output of a filter module (dotted line) forming part of an embodiment of the present invention;

FIG. 2 illustrates functional components of a switched mode power supply according to a first embodiment of the present invention;

FIG. 3 shows an example implementation of the ripple component estimation module illustrated in FIG. 2;

FIG. 4 shows an exemplary hardware implementation of the controller shown in FIG. 2;

FIG. 5 is a flow diagram illustrating operations performed by the controller in the first embodiment to generate control signals for the output voltage of the SMPS;

FIGS. 6A to 6C show simulations of the input signal, the estimated ripple component and the transient with attenuated ripple in the first embodiment;

FIGS. 7A to 7C show simulations of the input signal, the estimated ripple component and the transient with attenuated ripple in a modification of the first embodiment;

FIGS. 8A to 8C show simulations of the input signal, the estimated ripple component and the transient with attenuated ripple in a second embodiment of the present invention;

FIG. 9 shows functional components of a controller according to a third embodiment of the present invention;

FIGS. 10A to 10C show simulations of the input signal, the estimated ripple component and the transient with attenuated ripple in the third embodiment of the present invention; and

FIG. 11 shows functional components of a controller according to a further embodiment of the present invention.

### DETAILED DESCRIPTION OF EMBODIMENTS

### Embodiment 1

FIG. 1 is a schematic showing an SMPS 100 according to an embodiment of the present invention.

In the present embodiment, the SMPS 100 comprises switch circuitry 110 having at least one switching element (e.g. MOSFET) that is arranged in the switch circuitry 110 and controlled to switch at a high frequency (e.g. tens to hundreds of kHz) and with a duty cycle so as to convert an input DC voltage Vᵢₙ of the SMPS 100 to an output voltage, which is filtered by a low-pass filter 120 of the SMPS (e.g. a first order LC filter comprising an inductor and one or more capacitors) to generate an output a DC voltage, Vₒᵤₜ, of the SMPS 100. The switch circuitry 110 may, as in the present embodiment, include an isolation transformer having a primary winding driven by a primary side circuit, and a secondary winding electromagnetically coupled to the primary winding and arranged to drive a secondary side circuit typically comprising a rectifying network, the one or more switching elements being provided in one or both of the primary and secondary side circuits. Suitable circuit topologies (e.g. buck, boost, isolated or not) and other details of the switch circuitry 110 (e.g. whether it is configured to be soft-switched or hard-switched), as well as details of the output filter 120, are well-known to those skilled in the art and will therefore not be described here.

The SMPS 100 further comprises a feedback loop which is arranged to regulate the output voltage Vₒᵤₜ of the SMPS 100 in accordance with a control law that is characterised by one or more control law parameters (e.g. PID values). The feedback loop operates on the basis of a signal that is indicative of the output voltage Vₒᵤₜ of the SMPS. This signal may, for example, be the output voltage Vₒᵤₜ itself or an error signal E obtained by subtracting one of Vₒᵤₜ and a reference signal V_{ref} from the other of Vₒᵤₜ and V_{ref}. In the present embodiment, the feedback loop comprises a subtraction module 130 that is configured to subtract Vₒᵤₜ from V_{ref}, and communicate the resulting error signal E to the SMPS controller 140 as an example of a signal that is indicative of Vₒᵤₜ.

The controller 140 comprises a sampling module 150 that is arranged to sample the error signal E at a frequency higher than a switching frequency, f_{sw}, of the SMPS 100, and temporarily store the sampled values. The sampling module 150 may, as in the present embodiment, oversample the error signal E by an integer factor N=16. Naturally, the oversampling factor N is not limited to 16 and may take any other integer value selected by the user. In embodiments where N is an integer and the operation of the sampling module 150 is synchronised with the transistor drive signals, N samples of the error signal E are obtained in each switching period T of the SMPS 100, with the i^{th} sample in each switching period being spaced apart from the i^{th} sample in the next (or previous) switching period by the switching period T of the SMPS, and with each of these samples having been obtained at the same time relative to the start of the respective switching period. Thus, the sampling module 150 can be considered to sample and hold N sets of corresponding samples of the error signal E, with the sample acquisition times of the samples in each set being spaced apart from one another by the switching period T. The number of samples in each of these sets may also be selected by the user, and can be considered to define a (moving) time window within which corresponding samples are averaged, as explained further below.

The controller 140 also includes a filter module 160 arranged to filter out the ripple component of the sampled signal E. The filter module 160 comprises a ripple component estimation module which is, in general, arranged to estimate the ripple component R by calculating, for each or some of the samples of the signal that have been received from the sampling module 150, an average sample value (e.g. a mean or a weighted average) using the sample value itself and sample values obtained at corresponding points in preceding switching periods of the SMPS 100, each of said corresponding points being separated from the sample by a respective integer number of switching periods of the SMPS. The corresponding points may alternatively be separated from said sample by a respective interval whose length is substantially equal to (i.e. within a tolerance band, such as 2%, 5% or 10%, of) said respective integer number of switching periods. In the present embodiment, the ripple component estimation module 162 is arranged to calculate a weighted average of the sample values (including the sample value itself) in the time window for each of the aforementioned N sets of samples. In this way, the ripple component estimation module 162 is able to obtain a good estimate of what the ripple component R should be at any point in time, by exploiting the reproducibility of the ripple from one switching period to the next during stable operation of the SMPS 100 (when no transients appear). The averaging process suppresses the influence of outlying sample values on the mean sample value, thereby allowing the ripple component R to be estimated with relatively high accuracy.

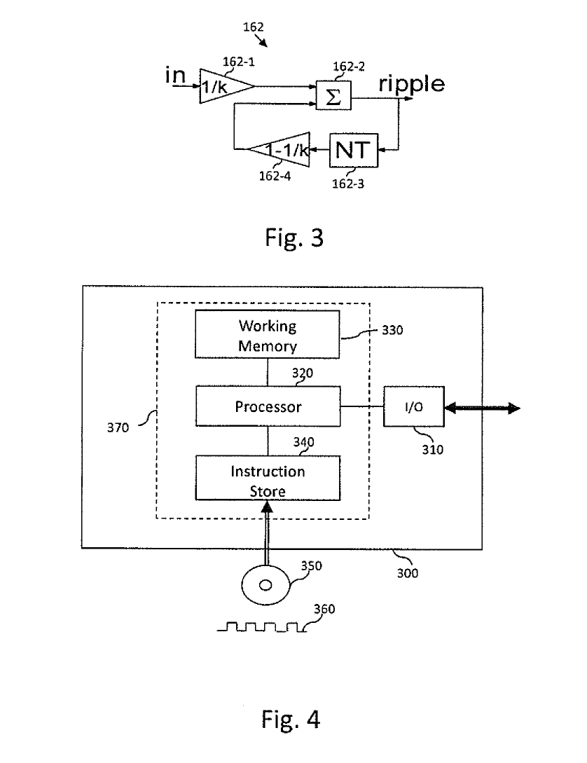

In the present embodiment, the ripple component estimation module 162 is arranged to estimate the ripple component R using an interpolated low-pass filter in the exemplary form of a first-order interpolated recursive moving average filter, as illustrated in FIG. 3. The factor k shown in FIG. 3 is approximately equal to the number of switching periods which are considered in the calculation of the average.

The interpolated recursive moving average filter in the example of FIG. 3 comprises a first scaling module 162-1 arranged to receive sample values of the sampled signal and scale each of the received sample values by a factor 1/k, and a summing module 162-2 arranged to add each of the scaled sample values to a respective sum of scaled sample values to generate a respective addition result. As shown in FIG. 3, the interpolated recursive moving average filter further comprises a feedback loop that processes the output of the summing module 162-2 and feeds the processing results back to an input of the summing module 162-2. In more detail, the feedback loop comprises a delay module 162-3 (e.g. in the form of a First In, First Out (FIFO) buffer) which is arranged to receive the addition results in the order in which the addition results are generated by the summing module 162-2, to store N of the received addition results at any one time, and to output a stored addition result I response to an addition result being received by the delay module 162-3 so that the stored addition results are output in the same order as they were received by the delay module 162-3. The feedback loop also includes a second scaling module 162-4, which is arranged to receive the addition results from the delay module 162-3 in the order in which they are output by the delay module 162-3, and to scale each received addition result by a factor 1−1/k in order to generate the respective sum of scaled sample values that is to be added to the respective scaled sample value by the summing module 162-2.

The transfer function from the input, in(z), to the output of the filter in FIG. 3, ripple(z), is given by

$$ripple ( z ) = \frac{1 \text{/} k}{1 - ( 1 - 1 \text{/} k ) {z}^{- N}} in ( z ) . \qquad Eqn . 1$$

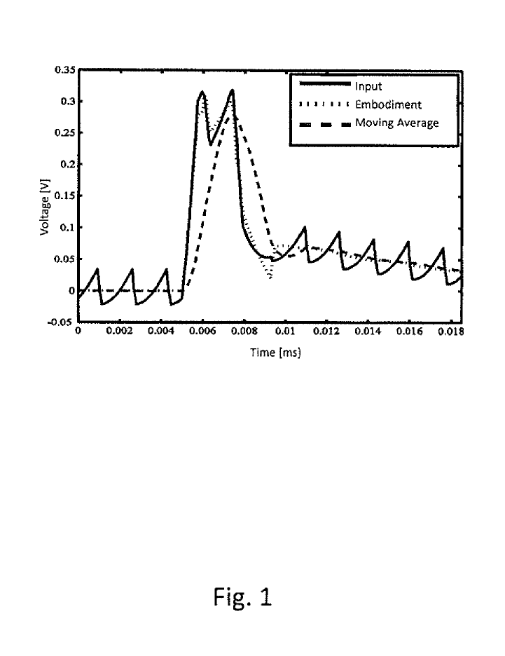

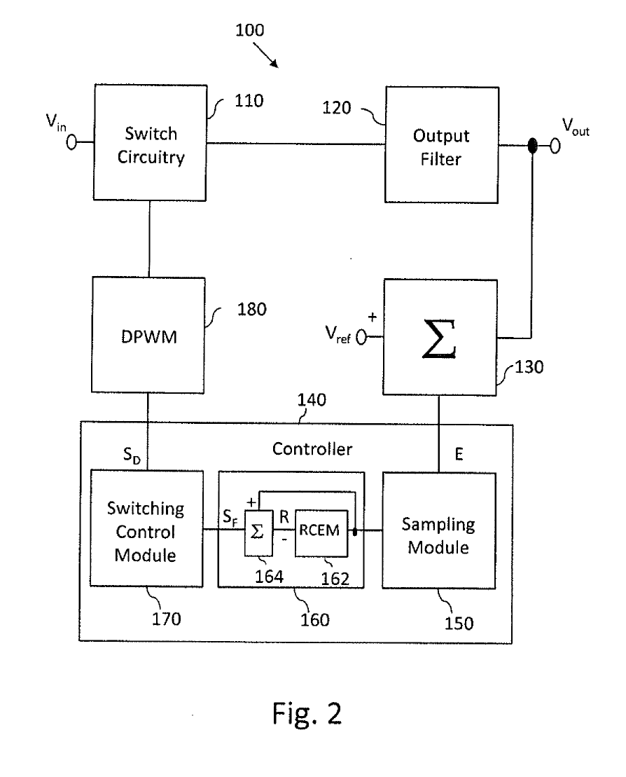

Referring again to FIG. 2, the filter module 160 also includes a subtraction module 164 arranged to subtract the estimated ripple component R from the sampled signal to generate a filtered signal S_{F}, and a switching control module 170, which is arranged to generate a control signal S_{D} for controlling the switching duty cycle of the SMPS 100 based on the filtered signal S_{F} from the filter module 160. The switching control module 170 may alternatively be configured to adjust the switching frequency of the SMPS 100, as noted above, or it may adjust both the switching duty cycle and the switching frequency of the SMPS 100. In such alternative embodiments, the sampling module 150 may be arranged to adjust its sampling frequency so as to keep it an integer multiple of the switching frequency.

Using Eqn. 1, the transfer function for the S_{F}(z) signal in FIG. 2 can be expressed as follows:

$${S}_{F} ( z ) = 1 - ripple ( z ) = [ 1 - \frac{1 \text{/} k}{1 - ( 1 - 1 \text{/} k ) {z}^{- N}} ] in ( z ) = \frac{( 1 - 1 \text{/} k ) [ 1 - {z}^{- N} ]}{1 - ( 1 - 1 \text{/} k ) {z}^{- N}} in ( z ) \qquad Eqn . 2$$

Equation 2 can be used as a variant for calculating the transient signal. However, this variant would require twice the memory, and the ripple component would not be calculated explicitly.

In other embodiments, the ripple component estimation module 162 may be arranged to estimate the ripple component R using a first-order interpolated low-pass filter in the alternative form of an interpolated Finite Impulse Response (FIR) filter (e.g. an interpolated moving average filter). Higher-order interpolated low-pass filters may alternatively be used, as will be discussed in the following.

In the present embodiment, the switching control module 170 takes the exemplary form of a PID regulator (also referred to herein as a PID controller) that regulates the duty cycle of the switching element(s) to keep the output voltage of the SMPS 100 constant, on the basis of received signal from the filter module 160 and in accordance with a PID control law that is characterised by the values of the P, I and D control parameters set in the PID regulator. However, in alternative embodiments, another kind of regulator, which regulates Vₒᵤₜ in accordance with a different control law that is defined using a different set of one or more control law parameters, may be used in place of the PID regulator. The PID regulator is arranged to generate control signals S_{D} (indicative of the required switching duty cycle) to control a digital pulse width modulator (DPWM) 180 also included in the feedback loop, to appropriately control the switching of the switching element(s) in the switch circuitry 110. The functionality of the components of the feedback loop illustrated in FIG. 2, and alternative ways of implementing and distributing these components among the primary and secondary sides of the isolation barrier of the SMPS 100 (where one is provided, as in the present embodiment), will be familiar to those skilled in the art, such that it is unnecessary to provide further details here.

FIG. 4 shows an exemplary implementation of the controller 140, in programmable signal processing hardware. The signal processing apparatus 300 shown in FIG. 4 comprises an input/output (I/O) section 310 for receiving the error signal E and transmitting control signals S_{D} to the DPWM 180. The signal processing apparatus 300 further comprises a processor 320, a working memory 330 and an instruction store 340 storing computer-readable instructions which, when executed by the processor 320, cause the processor 320 to perform the processing operations hereinafter described to control the output voltage of the SMPS 100. The instruction store 340 may comprise a ROM which is pre-loaded with the computer-readable instructions. Alternatively, the instruction store 340 may comprise a RAM or similar type of memory, and the computer readable instructions can be input thereto from a computer program product, such as a computer-readable storage medium 350 such as a CD-ROM, etc. or a computer-readable signal 360 carrying the computer-readable instructions.

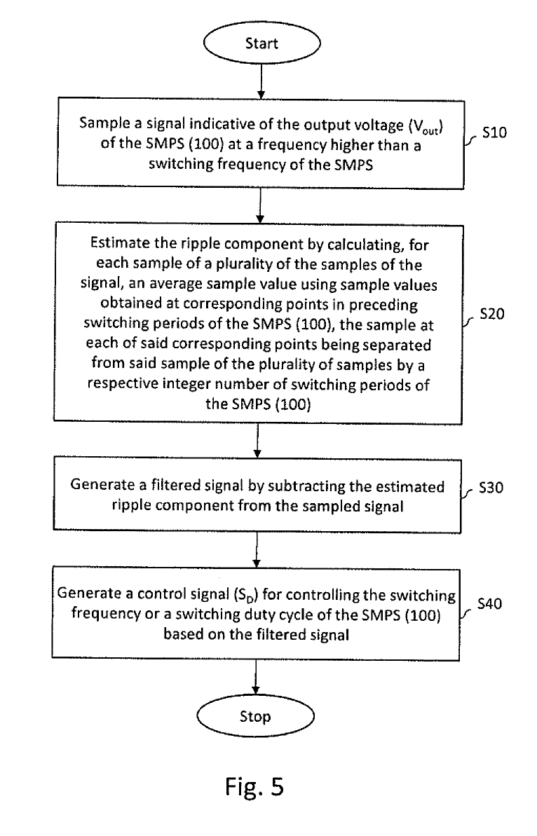

In the present embodiment, the combination 370 of the hardware components shown in FIG. 4, comprising the processor 320, the working memory 330 and the instruction store 340, is configured to implement the functionality of the aforementioned sampling module 150, filter module 160 (including the ripple component estimation module 162 and the subtraction module 164) and switching control module 170, which will now be described in detail with reference to FIG. 5.

FIG. 5 is a flow chart illustrating operations performed by the controller 140 in the first embodiment to generate control signals for the output voltage of the SMPS 100.

In step S10, the sampling module 150 samples the error signal E (as an example of a signal indicative of the output voltage of the SMPS 100) at a frequency higher than a switching frequency, f_{sw}, of the SMPS 100.

In step S20, the ripple component estimation module estimates the ripple component R by calculating, for each or some of the samples of the signal, an average sample value using the sample value and sample values obtained at corresponding points in preceding switching periods of the SMPS 100, the sample at each of said corresponding points being separated from the latest sample under consideration by a respective integer number of switching periods of the SMPS. More particularly, in the present embodiment, the ripple component estimation module 162 calculates a weighted average of the sample values including the sample value, in the time window for each of the aforementioned N sets of samples. As explained above, the ripple component estimation module 162 estimates the ripple component R using an interpolated low-pass filter in the exemplary form of a first-order interpolated recursive moving average filter, as illustrated in FIG. 3. As noted above, the ripple component estimation module 162 may alternatively estimate the ripple component R in step S20 using a first-order interpolated low-pass filter in the form of an interpolated FIR filter (e.g. an interpolated moving average filter). As a further alternative, higher-order interpolated low-pass filters may be used.

In step S30, the subtraction module 164 subtracts the estimated ripple component R from the sampled signal to generate a filtered signal, S_{F}.

Finally, in step S40, the switching control module 170 generates a control signal S_{D} for controlling the switching duty cycle D of the SMPS 100 based on the filtered signal S_{F} obtained in step S30.

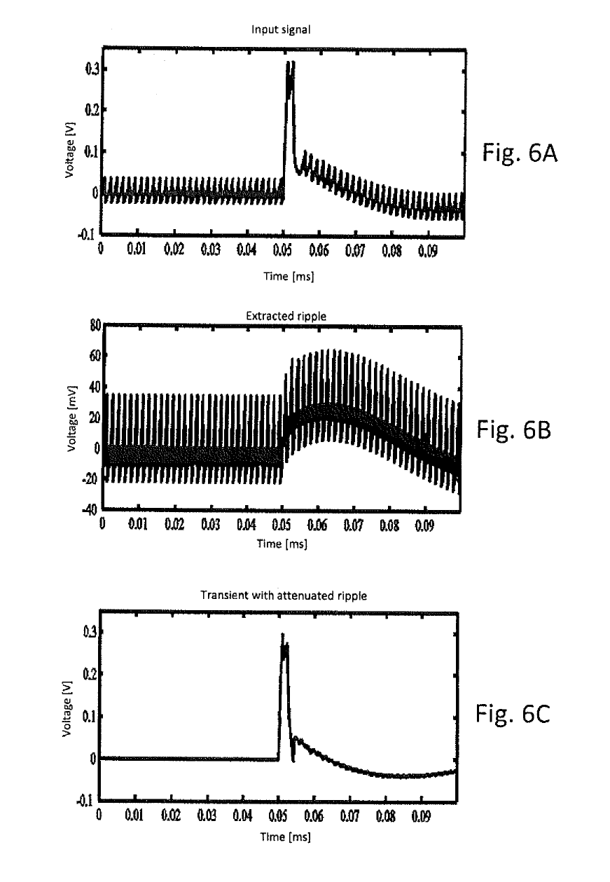

The ability of the filter module 160 of the present embodiment to effectively suppress the ripple component without significantly delaying or distorting the underlying feedback signal is illustrated in the simulation results in FIGS. 6A to 6C. FIG. 6A shows a simulation of the feedback signal input to the filter module 160 over a period of 0.1 ms, FIG. 6B shows the ripple component estimated by the ripple component estimation module 162 during that period, and FIG. 6C shows the simulated output of the filter module 160. In this example, the factor k (see FIG. 3 and the accompanying description thereof above) is set to 19. As shown in FIG. 6C, a good, essentially ripple-free transient signal is obtained. However, in the ripple trace in FIG. 6B, the voltage transient is readily apparent, with the peak of the transient appearing about 20 mV above the ripple's peak value.

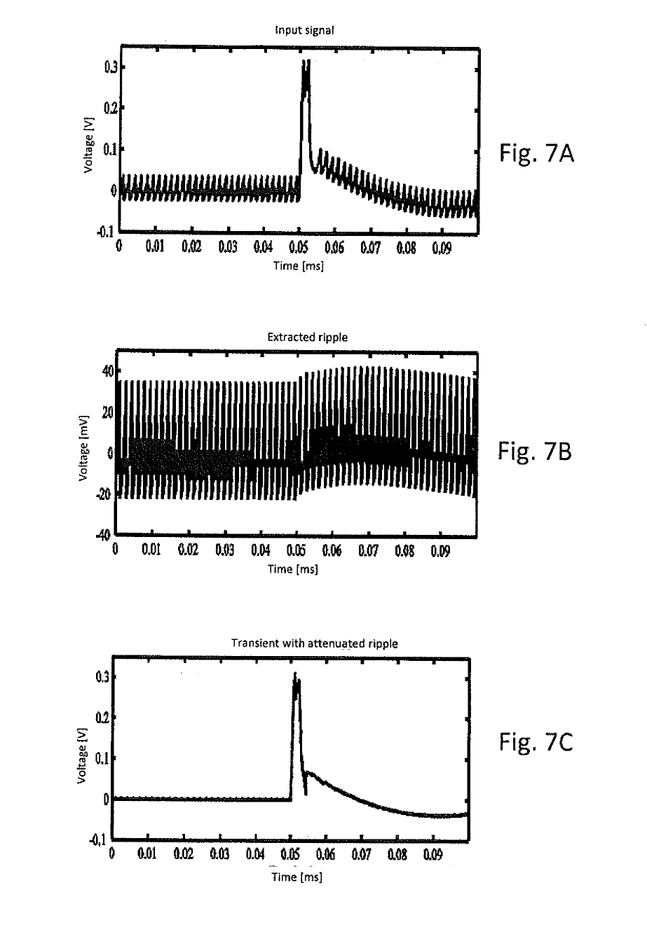

A simple improvement of the transient attenuation in the ripple extraction is to increase the factor k. Simulations with k=100 are shown in FIGS. 7A to 7C. In this variation of the first embodiment, the transient in the estimated ripple component is only a few millivolts above the normal ripple. However, the draw-back of this variation is that the filter takes a relatively long time to adjust for changes in the ripple due to, e.g. changes in the load level or the input voltage Vᵢₙ. The group delay is k−1 samples for low frequencies, i.e. the pass-band of the filter. Using a corresponding interpolated FIR filter with similar attenuation as the recursive filter with k=100 would have a filter length of N×k and a group delay of Nk/2, which will be very long in many cases and require a lot of memory.

### Embodiment 2

An effective approach to suppressing the appearance of the transient in the extracted ripple component is to increase the order of the filter in the ripple component estimation module 162 to two or higher. The present embodiment is based on this approach and differs from the first embodiment by the provision in the ripple component estimation module 162 of a low-pass filter in the form of a Chebychev Type 2 filter of order three, with a normalized band stop frequency of 0.1, where 1 corresponds to the Nyquist frequency and the attenuation in the stop band is 80 dB. Aside from the replacement of the first-order interpolated recursive moving average filter with the aforementioned Chebychev filter, the present embodiment is otherwise the same as the first embodiment.

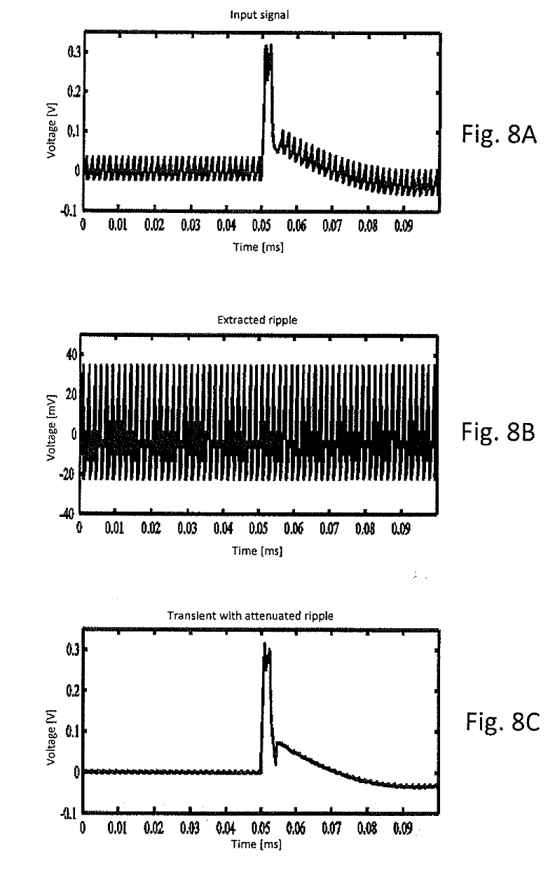

Simulation results for the second embodiment are shown in FIGS. 8A to 8C, from which it is clear that the transient in the ripple component is virtually eliminated (see FIG. 8B). By appropriate design of the higher-order filter, the latency can be reduced compared with the extremely low bandwidth first-order filter (i.e. the above-described variant of the first embodiment, where the filter has a large value of k). Using the filter of the present embodiment, the group delay in the pass band is about 80 samples. This can be reduced by increasing the stop band limit, e.g. a limit of 0.15 reduces the group delay to 55 samples, without greatly affecting the transient attenuation.

### Embodiment 3

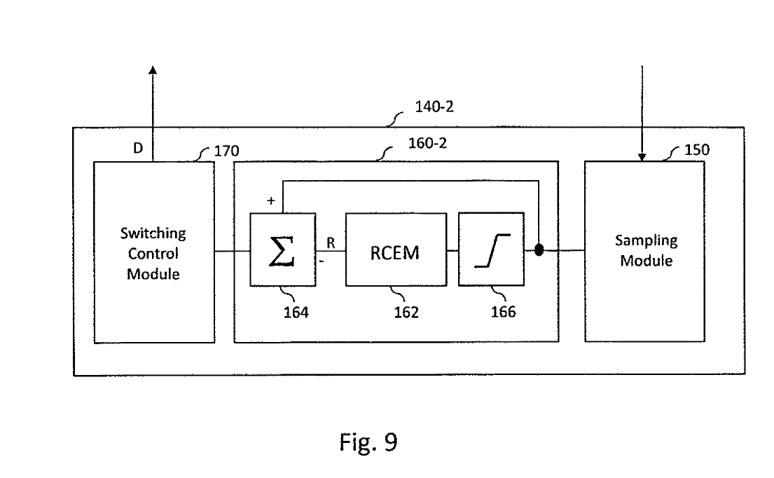

Another effective but simpler approach to suppressing the appearance of the transient in the extracted ripple component is to saturate the signal input to the ripple component estimation module 160 just above the normal ripple level. The present embodiment is based on this approach and differs from the first embodiment by the modified filter module 140-2 of the present embodiment further comprising, as shown in FIG. 9, a clipping module 166 that is arranged to condition the sampled signal by clipping the sampled signal when it exceeds a threshold level, preferably just above the normal ripple level (e.g. 2, 5 or 10% above the ripple level during stable operation of the SMPS, when no voltage transients occur). In other words, the clipping module 166 performs a signal clipping operation, allowing the signal input thereto to pass through unchanged if the amplitude of the input signal is below the threshold level, and outputting a signal at the threshold level when the input signal amplitude is at or above the threshold level. The present embodiment is otherwise the same as the first embodiment. In the present embodiment, the ripple component estimation module 162 is arranged to estimate the ripple component R by calculating, for each of a plurality of samples of the conditioned signal, an average of the sample value and the values of samples at corresponding points in preceding switching periods of the SMPS 100 that have been sampled and conditioned.

The operations performed by the controller 140-2 of the present embodiment are as described above with reference to FIG. 5, except that a further step is performed, between steps S10 and S20, of conditioning the sampled signal by clipping the sampled signal when it exceeds a threshold. In this case, the ripple component is estimated (in a modified version of step S20) by calculating, for each of the plurality of samples of the conditioned signal, an average of the sample value and the values of samples at corresponding points in preceding switching periods of the SMPS 100 that have been sampled and conditioned.

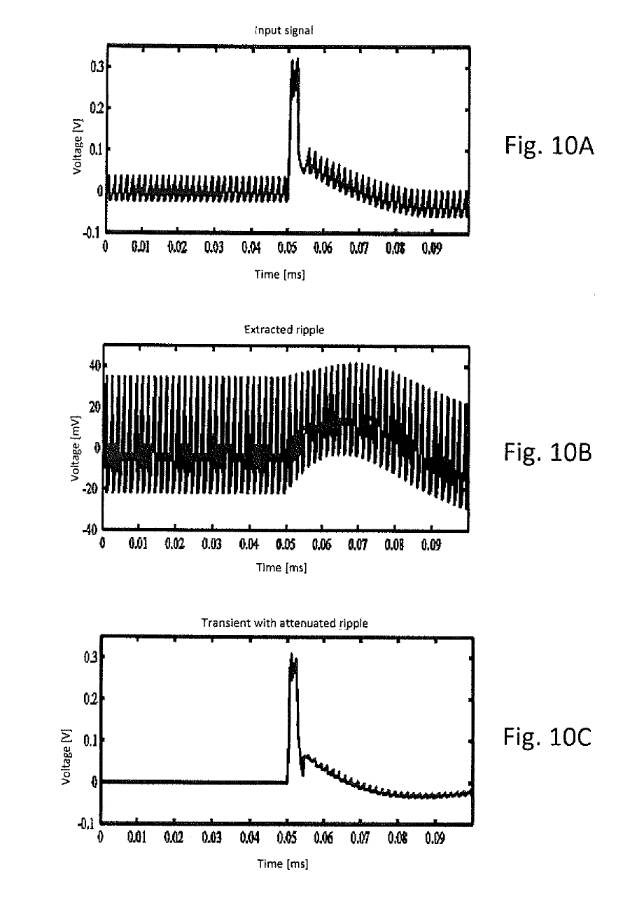

Simulation results for the third embodiment are shown in FIGS. 10A to 10C. In this simulation, the saturation limits in the clipping module 16 were set to ±50 mV. As seen in FIG. 10B, the ripple component estimate becomes a little distorted during the transient but the peak level is similar to the normal ripple. In the transient signal (FIG. 10C), the ripple shows up after the transient has occurred, due to the ripple signal having an offset.

### MODIFICATIONS AND VARIATIONS

Many modifications and variations can be made to the embodiments described above.

For example, in the above-described first embodiment, the subtraction module 130 could be replaced by a module at the output of the sampling module 150 (or an operation done by the sampling module itself), which shifts each sample value by a value representative of a target voltage, in order to digitally generate the error signal.

Furthermore, the above-described Chebychev Type-2 filter is only an example of a higher-order filter that is optimized to yield a flat response in the pass-band and equal ripple in the stop-band. Other optimizations, such as Butterworth, Chebychev Type-1, elliptic, or even Bessel could alternatively be used. Another possibility would be a filter optimized for minimizing the number of 1's, which would simplify hardware requirements for the multiplications.

Furthermore, although the controller 140, 140-2 of the above embodiments is configured to suppress a ripple component of the feedback signal at the switching frequency of the SMPS 100, the controller may alternatively or additionally have one or more parallel modules arranged to suppress a ripple component of the feedback signal at one or more harmonics of the fundamental frequency of the ripple component. In these embodiments, the sampling frequency could, for example, be set to N×2f_{sw} to eliminate the second harmonic, N×3f_{sw} to eliminate the third harmonic, etc.

Furthermore, the filter module 160 need not perform its averaging calculations using sample values located at corresponding points in consecutive periods of the ripple component to be filtered out. Thus, adjacent corresponding points considered in the estimation may alternatively be separated from each other by an integer number of ripple periods that is greater than one.

As another modification, the oversampling factor N does not need to be an integer. If, for example, N was set to 16.5, the received signal would be sampled at corresponding points every two switching periods. The filter module 160 would in that case estimate an average sample value by using sample values which are separated from the sample by an even integer number of switching periods (i.e. multiple of 2).

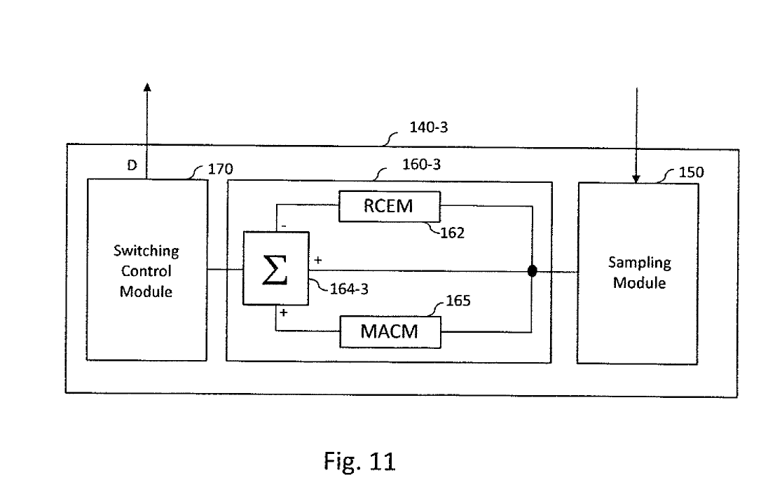

The configurations of the filter module 160 described above allow the ripple component to be effectively removed whilst allowing variations in the output voltage Vₒᵤₜ of the SMPS to propagate to the switching control module 170, provided that those output voltage variations occur on a time scale that is not much longer than the aforementioned time window that is used by the ripple component estimation module 162 to calculate the average sample values. This is because, during operation of the SMPS 100 in the case where Vₒᵤₜ is essentially constant on the time scale of the averaging window, the result of subtracting the estimated ripple component from the sampled output voltage signal is substantially zero, regardless of the value of Vₒᵤₜ−V_{ref} In order to make the filter module more effective in suppressing slow drifts of the output voltage of the SMPS 100 from the target value, the filter module may be adapted to further comprise a moving average calculation module that is arranged to calculate a moving average of the sampled signal by calculating, for each sample of a plurality of the samples of the signal, an average (e.g. a mean) of a predetermined number of preceding sample values (e.g. in the case of the first or third embodiment, kN preceding sample values). In this variant, the subtraction module would be arranged to generate the filtered signal by subtracting the estimated ripple component from a sum of the sampled signal and the calculated moving average. A controller 140-3 according to such a variant is illustrated in FIG. 11, where the modified filter module 160-3 comprises a RCEM 162 as in the first embodiment, as well as a moving average calculation module (MACM) 165 and a modified subtraction module 164-3. The MACM 165 effectively suppresses any DC output voltage error/offset that might be introduced into the system (e.g. at start-up of the SMPS 100). In this variant, the process described above with reference to FIG. 5 would be modified by inclusion of an additional step (performed either between steps S10 and S20 or between steps S20 and S30, or in parallel with step S20) of calculating a moving average of the sampled signal by calculating, for each sample of a plurality of the samples of the signal, an average of a predetermined number of preceding sample value. The filtered signal would then be generated by subtracting the estimated ripple component from a sum of the sampled signal and the calculated moving average in a modified version of step S30.

1. A controller for controlling an output voltage of a switched mode power supply (SMPS) the controller comprising:
a sampling module arranged to sample a signal indicative of the output voltage of the SMPS at a frequency higher than a switching frequency of the SMPS;
a filter module arranged to filter out a ripple component of the sampled signal, comprising:
a ripple component estimation module arranged to estimate the ripple component by calculating, for each sample of a plurality of the samples of the signal, an average sample value using the sample value and sample values obtained at corresponding points in preceding switching periods of the SMPS, the sample at each of said corresponding points being separated from said sample of the plurality of samples by a respective integer number of switching periods of the SMPS; and
a subtraction module arranged to subtract the estimated ripple component from the sampled signal to generate a filtered signal; and
a switching control module arranged to generate a control signal for controlling at least one of the switching frequency and a switching duty cycle of the SMPS based on the filtered signal.

2. The controller according to claim 1, wherein the sampling module is arranged to sample the signal indicative of the output voltage of the SMPS at a frequency that is an integer multiple of the switching frequency of the SMPS.

3. The controller according to claim 1, wherein the ripple component estimation module is arranged to estimate the ripple component by use of an interpolated low-pass filter.

4. The controller according to claim 3, wherein the interpolated low-pass filter is an interpolated Finite Impulse Response filter.

5. The controller according to claim 4, wherein the interpolated Finite Impulse Response filter is an interpolated moving average filter.

6. The controller according to claim 3, wherein the interpolated low-pass filter is an interpolated recursive moving average filter.

7. The controller according to claim 6, wherein the sampling module is arranged to sample the signal indicative of the output voltage of the SMPS at a frequency N·f_{SW}, where N is an integer and f_{SW} is the switching frequency of the SMPS, and the interpolated recursive moving average filter comprises:
a first scaling module arranged to receive sample values of the sampled signal and scale each of the received sample values by a factor 1/k, where k is an integer indicative of the number of switching periods of the SMPS in the calculation of the average sample value performed by the ripple component estimation module;
a summing module arranged to add each of the scaled sample values to a respective sum of scaled sample values to generate a respective addition result; and
a feedback loop comprising:
a delay module arranged to receive the addition results in the order in which the addition results are generated by the summing module, store N of the received addition results at a time, and output a stored addition result when an addition result is received by the delay module such that the stored addition results are output in the same order as they were received by the delay module; and
a second scaling module arranged to receive the addition results from the delay module in the order in which they are output by the delay module and scale each received addition result by a factor 1−1/k to generate the respective sum of scaled sample values that is to be added to the respective scaled sample value by the summing module.

8. The controller according to claim 3, wherein the interpolated low-pass filter is of order 2 or higher.

9. The controller according to claim 1, wherein the filter module further comprises a clipping module arranged to process the sampled signal by clipping the sampled signal when it exceeds a threshold, and the ripple component estimation module is arranged to estimate the ripple component by calculating, for each sample of a plurality of samples of the processed signal, an average sample value using the sample value and sample values obtained at corresponding points in preceding switching periods of the SMPS that have been sampled and processed.

10. The controller according to claim 1, wherein:
the filter module further comprises a moving average calculation module arranged to calculate a moving average of the sampled signal by calculating, for each sample of a plurality of the samples of the signal, an average of a predetermined number of preceding sample values; and
the subtraction module is arranged to generate the filtered signal by subtracting the estimated ripple component from a sum of the sampled signal and the calculated moving average.

11. A switched mode power supply comprising a controller according to claim 1.

12. A method of controlling an output voltage of a switched mode power supply (SMPS), the method comprising:
sampling a signal indicative of the output voltage of the SMPS at a frequency higher than a switching frequency of the SMPS;
estimating the ripple component by calculating, for each sample of a plurality of the samples of the signal, an average sample value using the sample value and sample values obtained at corresponding points in preceding switching periods of the SMPS, the sample at each of said corresponding points being separated from said sample of the plurality of samples by a respective integer number of switching periods of the SMPS;
generating a filtered signal by subtracting the estimated ripple component from the sampled signal; and
generating a control signal for controlling at least one of the switching frequency and a switching duty cycle of the SMPS based on the filtered signal.

13. The method according to claim 12, wherein the signal indicative of the output voltage of the SMPS is sampled at a frequency that is an integer multiple of the switching frequency of the SMPS.

14. The method according to claim 12, wherein the ripple component is estimated by use of an interpolated low-pass filter.

15. The method according to claim 14, wherein the interpolated low-pass filter is an interpolated Finite Impulse Response filter.

16. The method according to claim 15, wherein the interpolated Finite Impulse Response filter is an interpolated moving average filter.

17. The method according to claim 14, wherein the interpolated low-pass filter is an interpolated recursive moving average filter.

18. The method according to claim 14, wherein the interpolated low-pass filter is of order 2 or higher.

19. The method according to claim 12, further comprising:
processing the sampled signal by clipping the sampled signal when it exceeds a threshold,
wherein the ripple component is estimated by calculating, for each of the plurality of samples of the processed signal, an average sample value using the sample value and sample values obtained at corresponding points in preceding switching periods of the SMPS that have been sampled and processed.

20. The method according to claim 12, further comprising:
calculating a moving average of the sampled signal by calculating, for each sample of a plurality of the samples of the signal, an average of a predetermined number of preceding sample values,
wherein the filtered signal is generated by subtracting the estimated ripple component from a sum of the sampled signal and the calculated moving average.

21. A non-transitory computer-readable storage medium storing computer program instructions which, when executed by a processor, cause the processor to perform a methods according to claim 12.

22. (canceled)
